(19) United States
(12) Patent Application Publication
(10) Pub. No.: US 2010/0287459 A1
(43) Pub. Date: Nov. 11, 2010

(54) REUSABLE BUSINESS LOGIC ACROSS USER INTERFACE CONTAINERS

(75) Inventors: Vijay Mital, Kirkland, WA (US); Suraj T. Poozhiyil, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/435,497

(22) Filed: May 5, 2009

(51) Int. Cl. G06F 17/30; G06F 17/00

(52) U.S. Cl. 715/221; 715/237; 707/E17.044

(57) ABSTRACT

Embodiments are provided for a user interface to reuse business logic related to an ordered business process for managing data in an electronic document. Data may be received in the electronic document in an order-independent manner. The received data may include metadata defining business logic which includes one or more restrictions on a current state of the received data. The business logic may be used to determine whether the received data conforms to the one or more restrictions on the current state of the received data. The user interface may generate a visualization when the received data does not conform to the one or more restrictions on the current state of the received data in the electronic document. The visualization may include one or more actions associated with the presentation of the received data in accordance with the business logic.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Data management applications allow for the creation of forms so that users (such as information workers) may view and update data in tracking applications, business applications, and workflows utilized in a business process. A single business process may utilize a set of multiple forms (such as forms utilized for tracking customer data, order data, and product data) which contain or invoke business logic. The business process may dictate that each form in the set may be created with a subset of the total required data. Furthermore, assumptions may be made about the state of the data entered into each form. For example, before making a current form available for receiving data, it is assumed that a previous form has already been used in an earlier step in the business process. The business logic may be used to validate the data entered in the forms. Drawbacks with current applications used in business processes include users having to determine which of multiple forms to use at a given stage in a business process and having to create workflows for providing a sequence for using multiple forms (predicated on a data state at the end of each form submission). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for a user interface to reuse business logic related to an ordered business process for managing data in an electronic document. Data may be received in the electronic document in an order-independent manner. The received data may include metadata defining business logic which includes one or more restrictions on a current state of the received data. The business logic may be used to determine whether the received data conforms to the one or more restrictions on the current state of the received data. The user interface may generate a visualization when the received data does not conform to the one or more restrictions on the current state of the received data in the electronic document. The visualization may include one or more actions associated with the presentation of the received data in accordance with the business logic.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for reusing business logic related to an ordered business process to manage data in an electronic document, in accordance with various embodiments;

FIG. 2 is a block diagram illustrating a computing environment which may be utilized for reusing business logic related to an ordered business process to manage data in an electronic document, in accordance with various embodiments;

FIG. 3 is a flow diagram illustrating a routine for reusing business logic related to an ordered business process to manage data in an electronic document, in accordance with various embodiments;

FIG. 4 is a flow diagram illustrating a routine for determining, using business logic, whether received data in the electronic document conforms with current data state restrictions, in accordance with various embodiments;

FIG. 5A is a computer screen display of a user interface displaying a visualization when received data does not conform with at least one restriction on a current data state in an electronic document, in accordance with one embodiment; and

FIG. 5B is a computer screen display of a user interface displaying a visualization when received data does not conform with at least one restriction on a current data state in an electronic document, in accordance with another embodiment.

### DETAILED DESCRIPTION

Embodiments are provided for a user interface to reuse business logic related to an ordered business process for managing data in an electronic document. Data may be received in the electronic document in an order-independent manner. The received data may include metadata defining business logic which includes one or more restrictions on a current state of the received data. The business logic may be used to determine whether the received data conforms to the one or more restrictions on the current state of the received data. The user interface may generate a visualization when the received data does not conform to the one or more restrictions on the current state of the received data in the electronic document. The visualization may include one or more actions associated with the presentation of the received data in accordance with the business logic.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

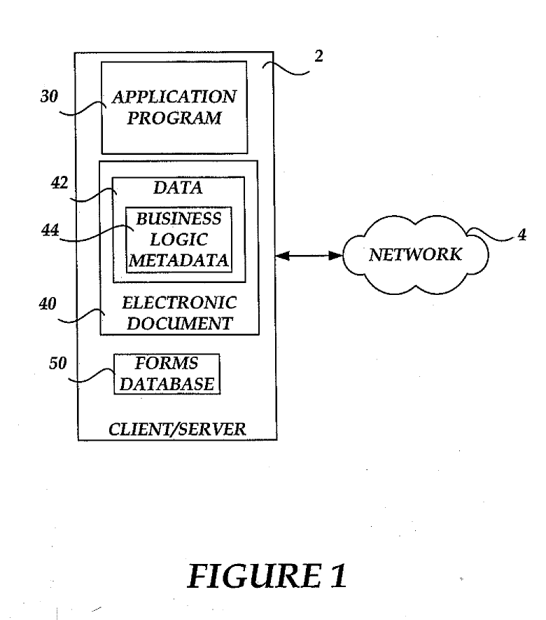

Referring now to the drawings, in which like numerals represent like elements through the several figures, various aspects of the present invention will be described. FIG. 1 is a block diagram illustrating a network architecture for reusing business logic related to an ordered business process to manage data in an electronic document, in accordance with various embodiments. The network architecture includes a client/server computer 2 (hereinafter referred to as the “computer 2”) which is in communication with a network 4 which may include a local network or a wide area network (e.g., the Internet). It should be understood that in accordance with various embodiments, the computer 2 may function as either a client computer or a server computer.

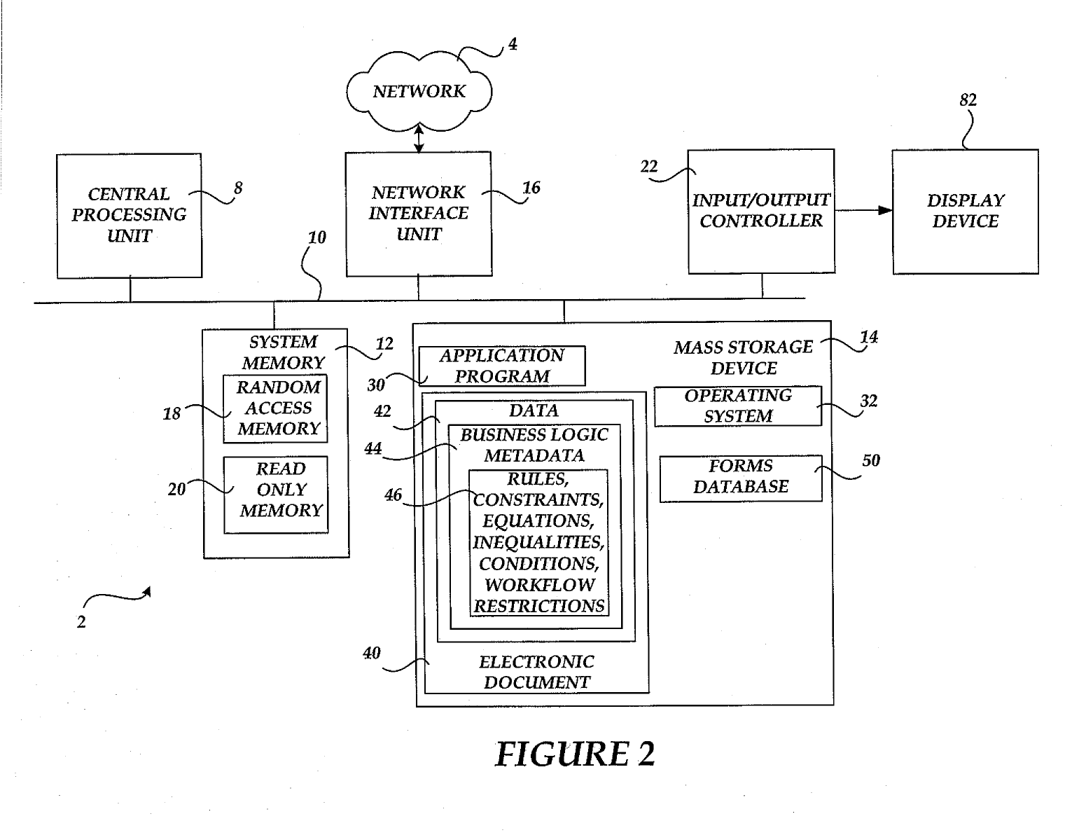

The computer 2 may store an application program 30, an electronic document 40 and a forms database 50. In accordance with various embodiments, the application program 30 may comprise a data management software application such as the ACCESS database software or the EXCEL spreadsheet software, manufactured by MICROSOFT CORPORATION of Redmond, Wash. It should be understood that the embodiments described herein should not be construed as being limited to the aforementioned software applications and that other data management software applications from other developers and/or manufacturers may also be utilized. As will be described in greater detail below in the discussion of FIGS. 2-X, the application program 30 may be utilized to generate a user interface for displaying a visualization (e.g., one or more actions associated with the presentation of received data in the electronic document 40) when data received in the electronic document does not conform to one or more restrictions associated with the data based on business logic. For example, in accordance with an embodiment, the electronic document 40 may be used to edit data stored in a customer order form which, according to business logic associated with the form, requires a customer to enter data in a predefined sequence (e.g., registration data must be entered prior to requesting a price quote for a product or service from a supplier). When the business logic restriction is violated (e.g., the customer requests the price quote before entering the registration data), the appropriate section of the electronic document 40 (e.g., the price quote section) a visualization comprising a highlighted spreadsheet cell may be generated to alert the user that this section of the electronic document 40 was edited out of order. Furthermore, a visualization comprising a prompt may also be generated to alert the user that the registration section of the electronic document should be completed prior to the price quote section.

The electronic document 40 stored on the computer 2 may comprise a spreadsheet or form generated by the application program 30 and may include data 42. In accordance with various embodiments, the data 42 may be received and displayed in spreadsheet cells or fields in the electronic document 40. The data 42 in the electronic document 42 may comprise form entries utilized to complete one or multiple forms for a business process, such as the taking of customer orders. The data 42 may include metadata which describes business logic (i.e., business logic metadata 44). In accordance with an embodiment, the business logic described by the business logic metadata 44 may be declared within a schema associated with the data 42. The business logic include decisions such as “when an order is deleted, also delete the line item,” when a customer has been contacted three times at an email address without a reply, mark the email address as ‘invalid,’” or “in the order entry form, ensure that the user is forced to enter a ‘promise date’ that is no less than 5 days after the date of the order being placed.”

The business logic described by the business logic metadata 44 may include restrictions on one or more states of the data 42 including, but not limited to, rules, constraints, equations, inequalities, conditions, and workflow restrictions associated with various data states that may be executed in a functional computing mode. In accordance with an embodiment, a model may be utilized in which visual objects, related data, and “analytics” (i.e., rules, constraints, equations, calculations and simulation instructions) are represented in a uniform way, as data, in a single data space. Parameters may be associated with the visual objects such that changing the value of the parameters changes the appearance or location of the visual objects. For example, the business logic metadata 44 may include a constraint (e.g., a pre-condition) on order data such that any open order must have at least three line items before the order can be closed. As another example, the business logic metadata 44 may include a spatial constraint specifying that there not be more than two inches between customer and order information in an electronic document. The functionality and structure of the above-described model with respect to the rules, constraints, equations, equations, conditions, and workflow restrictions included in the business logic described by the business logic metadata 44 is described in greater detail in related patent application U.S. Ser. No. 12/163,867 entitled “Interpretive Computing over Visualizations, Data and Analytics,” filed on Jun. 27, 2008, the disclosure of which is incorporated herein, in its entirety, by reference.

The forms database 50 may comprise a set of forms associated with one or more business processes and may be utilized by the application program 30 to track a current state of the data 42 (i.e., data edits) received in the electronic document 40. In accordance with various embodiments, a single business process may utilize multiple forms and the electronic document 40 generated by the application program 30 may be utilized to receive edits for form data corresponding to the forms stored in the forms database 50.

### Exemplary Operating Environment

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computing device, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the computer 2 which may include a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing the application program 30, an operating system 32, the application program 30, the electronic document 40, and the forms database 50. In accordance with various embodiments, the electronic document 40 may include the data 42. The data 42 may include the business logic metadata 44. The business logic metadata 44 may include rules, constraints, equations, inequalities, conditions, and workflow restrictions 46.

In accordance with various embodiments, the operating system 32 may be suitable for controlling the operation of a networked personal computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the computer 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments of the invention, the computer 2 may operate in a networked environment using logical connections to remote computers through the network 4 which, as discussed above, may include a local network or a wide area network (e.g., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means (not shown). Similarly, an input/output controller 22 may provide output to a display device 82 as well as a printer, or other type of output device (not shown).

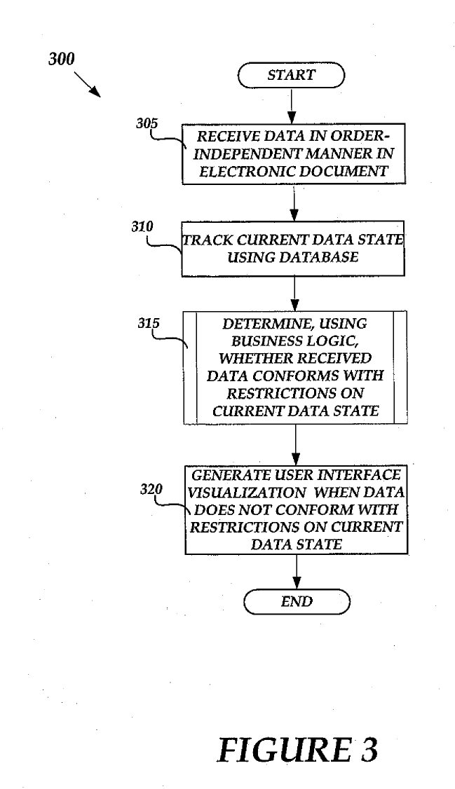

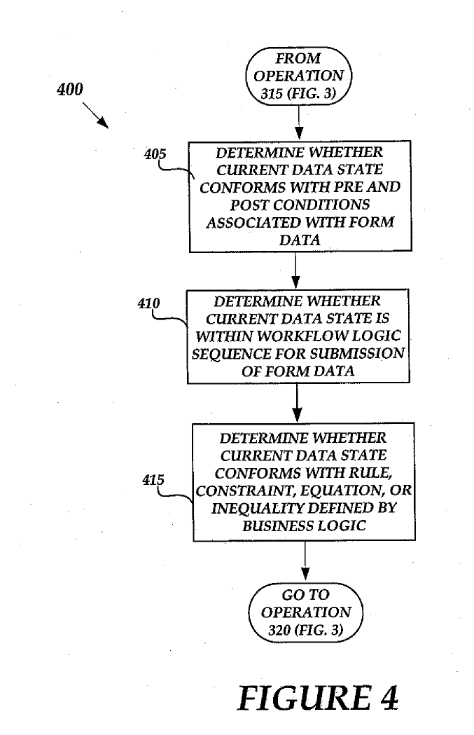

FIG. 3 is a flow diagram illustrating a routine 300 for reusing business logic related to an ordered business process to manage data in an electronic document, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 3-4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 300 begins at operation 305, where the application program 30 (which is executed by the central processing unit 8 on the computer 2) may receive the data 42 in an order-independent manner in the electronic document 40. For example, the application program 30 may receive edits to existing data in the electronic document 40 which corresponds to a business process in which multiple forms are typically utilized to receive data in a pre-defined order (the business process may also restricted to utilizing the forms in a pre-defined order). In accordance with various embodiments, the application program 30 may be utilized to receive data in the electronic document 40 without regard to the pre-defined order restrictions established by a business process.

From operation 305, the routine 300 continues to operation 310, where the application program 30 utilizes the forms database 50 to track the current state of the data 42 received in the electronic document. In particular, the application program 30 may utilize the forms database 50 to determine, based on the type of the data 42 and how the data 42 is typically entered into a corresponding business process. For example, it the data 42 entered into the electronic document 40 is price quote data, the application program 30 may utilize the forms database 50 to determine that, according to forms associated with the corresponding business process, price quote data should be received after customer registration data and no registration data has yet been received. Thus, in the aforementioned example, the application program 30 has determined that the current state of the received price quote data is that it has been received prior to customer registration data with regard to the corresponding business process.

From operation 310, the routine 300 continues to operation 315, where the application program 30 may determine, using business logic (associated with a business process), whether the received data 42 conforms to any restrictions on the current data state of the data 42. In particular, the application program 30 may review the business logic metadata 44 in the data 42 for any rules, constraints, equations, inequalities, condition, or workflows 46 associated with the corresponding business process. An illustrative routine for determining, using business logic, whether the received data 42 in the electronic document 40 conforms with current data state restrictions will be described in greater detail below in the discussion of FIG. 4.

From operation 315, the routine 300 continues to operation 320, where the application program 30 may generate a user interface visualization (e.g., on the display device 82 of the computer 2) when the data 42 does not conform to any restrictions on a current data state. For example, in a user interface comprising a spreadsheet representing the electronic document 40, the application program 30 may cause one or more spreadsheet cells containing the data 42 to display a prompt informing a user of the electronic document that at least a portion of the data 42 does not conform with a rule, constraint, equation, inequality, condition, or workflow 46 specified in the business logic metadata 44 (i.e., defined by the business logic). In accordance with another embodiment, the visualization generated by the application program 30 may include highlighting at least a portion of the data 42 which does not conform to a rule, constraint, equation, inequality, condition, or workflow 46 specified in the business logic metadata 44. In accordance with another embodiment, the visualization generated by the application program 30 may include resizing at least a portion of the data 42 which does not conform to a rule, constraint, equation, inequality, condition, or workflow 46 specified in the business logic metadata 44. For example, the application program 30 may resize received customer data so that is displayed two inches away from order data in an electronic document in order to conform to a constraint specifying that that there not be more than two inches between customer and order information in an electronic document. It should be appreciated that, in accordance with an embodiment, in response to viewing the visualization generated by the application program 30 in the electronic document 40, a user of the electronic document 40 may then edit any non-conforming data 42 so that it conforms to the business logic utilized in a business process or, alternatively, the application program 30 may edit any non-conforming data 42 automatically. For example, in response to receiving a prompt that the price quote data entered by a user should have been received (according to the business logic) after customer registration data and no registration data has yet been received, the user may enter the customer registration data into the electronic document 40. From operation 320, the routine 300 then ends.

FIG. 4 is a flow diagram illustrating a routine 400 for determining, using business logic, whether the received data 42 in the electronic document 40 conforms to current data state restrictions, in accordance with various embodiments. The routine 400 begins from operation 315 of FIG. 3 and continues to operation 405, where the application program 30 determines whether a current data state for the data 42 conforms to pre and/or post conditions (defined by business logic) associated with the entry of form data in one or more forms associated with a business process. For example, a post-condition may specify that that there not be more than two inches between customer data and order data in an electronic document after both types of data have been received.

From operation 405, the routine 400 continues to operation 410 where the application program 30 determines whether a current data state for the data 42 is within a workflow logic sequence associated with the submission of form data in one or more forms associated with a business process. For example, a workflow logic sequence may specify that customer registration data be received prior to price quote data.

From operation 410, the routine 400 continues to operation 415 where the application program 30 determines whether a current data state for the data 42 conforms to a rule, constraint, equation, or inequality defined by the business logic. For example, the business logic may include a rule that there should be three line items before an open order can be closed. From operation 415, the routine 400 returns to operation 320 of FIG. 3.

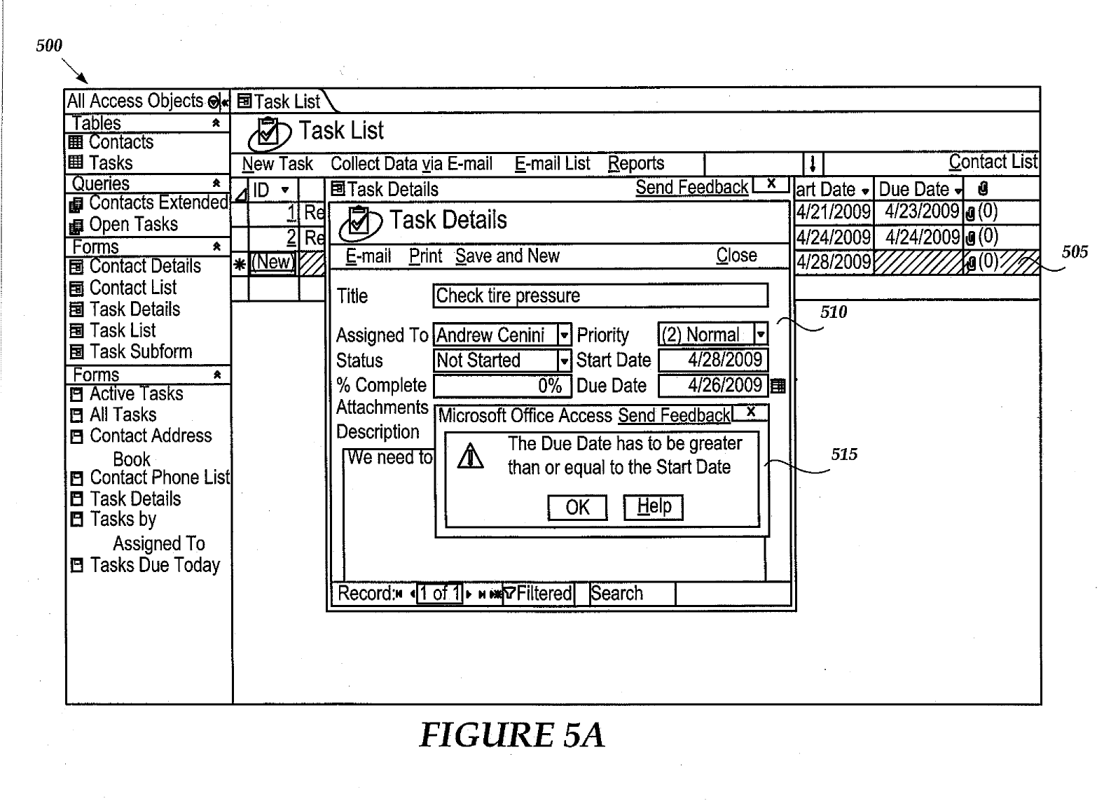

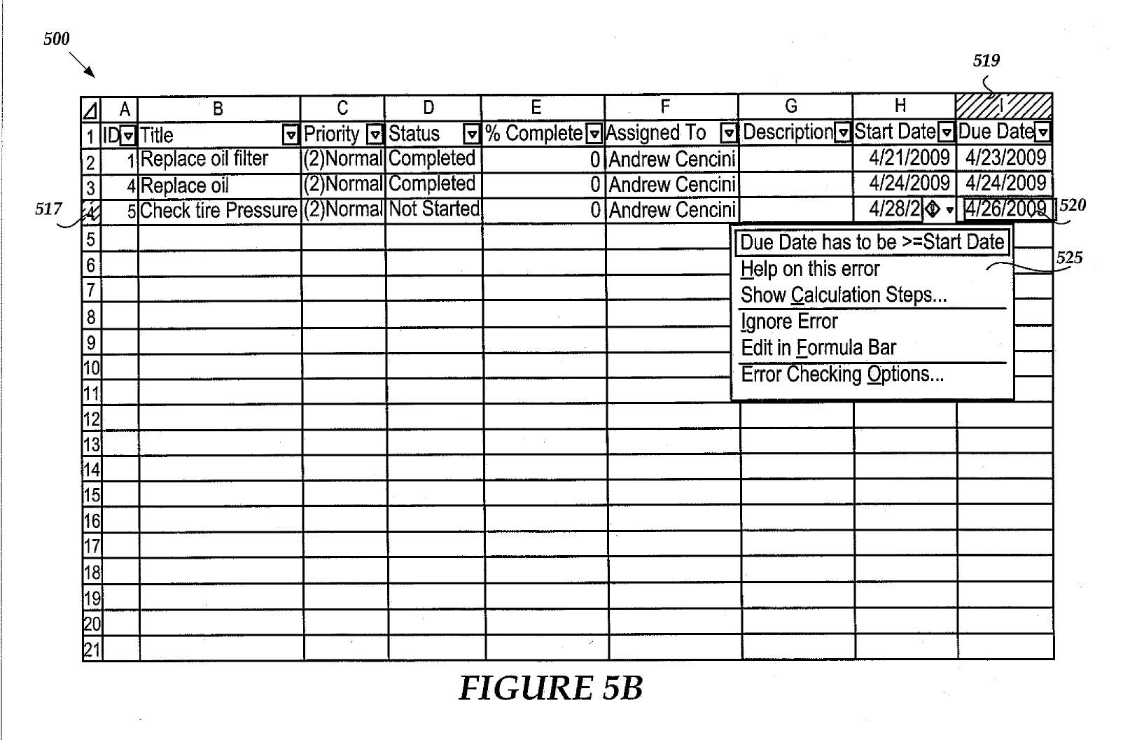

FIG. 5A is a computer screen display of a user interface 500, generated by the application program 30, displaying a visualization when received data does not conform with the at least one restriction on a current data state in an electronic document, in accordance with one embodiment. The user interface 500 may, for example, comprise a Task List database form 505 for creating various tasks. Upon a user selecting a task field in the form 505, the user interface 500 may be configured to generate a Task Details window 510 to enter data for a task to be created. In accordance with the present embodiment, the application program 30 may determine, using business logic, whether the data received in the window 510 conforms to any restrictions on the current data state of other data entered in the window 510. If any data does not conform to a restriction defined by the business logic, the application program 30 may generate a prompt 515 to alert a user with respect to data which is currently being entered into the user interface 500. For example, a user entering a due date for a task which is prior to a start date violates a constraint that the due date has to be grater than or equal to the start date.

FIG. 5B is a computer screen display of the user interface 500, generated by the application program 30, displaying a visualization when received data does not conform with the at least one restriction on a current data state in an electronic document, in accordance with another embodiment. In this embodiment, the user interface 500 may, for example, comprise a Task List spreadsheet for creating various tasks. After entering data corresponding to a task in the spreadsheet, the application program 30 may determine, using business logic, whether any of the received data conforms to any restrictions on the current data state of other data entered in the spreadsheet. If any data does not conform to a restriction defined by the business logic, the application program 30 may generate a prompt 525 to alert a user with respect to data which is currently being entered into the user interface 500. The application program 30 may also be configured to highlight a row and column in the spreadsheet containing the non-conforming data. For example, the due date data being entered in spreadsheet cell 520 violates a constraint that the due date has to be grater than or equal to the start date. As a result, the application program 30 may generate a prompt 525 and also highlight row 517 and column 519 which corresponds to the non-conforming data.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of providing a user interface for reusing business logic related to an ordered business process to manage data in an electronic document, comprising:
receiving, by a computer, the data in the electronic document in an order-independent manner, the received data comprising metadata defining business logic comprising at least one restriction on a current state of the received data;
determining, using the business logic, whether the received data conforms with the at least one restriction on the current state of the received data; and
generating, in a user interface, a visualization when the received data does not conform with the at least one restriction on the current state of the received data in the electronic document, the visualization comprising at least one action associated with the presentation of the received data in accordance with the business logic.

2. The method of claim 1 further comprising utilizing a database to track the current state of the received data.

3. The method of claim 1, wherein receiving the data in the electronic document in an ordered-independent manner comprises receiving edits to existing data in the electronic document.

4. The method of claim 1, wherein determining, using the business logic, whether the received data conforms with the at least one restriction on the current state of the data comprises determining, using the business logic, whether the current state of the data conforms with at least one of a pre-condition and a post-condition associated with the submission of data for at least one form.

5. The method of claim 1, wherein determining, using the business logic, whether the received data conforms with the at least one restriction on the current state of the data comprises determining, using the business logic, where the current state of the data falls within a workflow logic sequence of tasks associated with the submission of data for at least one form.

6. The method of claim 1, wherein determining, using the business logic, whether the received data conforms with the at least one restriction on the current state of the data comprises determining, using the business logic, whether the current state of the data conforms with at least one of a rule, constraint, equation, and inequality defined by the business logic.

7. The method of claim 6, wherein generating, in a user interface, a visualization when the received data does not conform with the at least one restriction on the current state of the received data in the electronic document comprises displaying a prompt to inform a user of the electronic document that at least a portion of the received data in the electronic document does not conform with the at least one of a rule, constraint, equation, and inequality defined by the business logic.

8. The method of claim 6, wherein generating, in a user interface, a visualization when the received data does not conform with the at least one restriction on the current state of the received data in the electronic document comprises highlighting at least a portion of the received data in the electronic document which does not conform with the at least one of a rule, constraint, equation, and inequality defined by the business logic.

9. A computer system for providing a user interface for reusing business logic related to an ordered business process to manage data in an electronic document, comprising:
a memory for storing executable program code; and
a processor, functionally coupled to the memory, the processor being responsive to computer-executable instructions contained in the program code and operative:
receive the data in the electronic document in an order-independent manner, the received data comprising metadata defining business logic comprising at least one restriction on a current state of the received data;
determine, using the business logic, whether the received data conforms with the at least one restriction on the current state of the received data; and
generate, in a user interface, a visualization when the received data does not conform with the at least one restriction on the current state of the received data in the electronic document, the visualization comprising at least one action associated with the presentation of the received data in accordance with the business logic.

10. The system of claim 9, wherein the processor is further operative to utilize a database to track the current state of the received data.

11. The system of claim 9, wherein the processor, in receiving the data in the electronic document in an ordered-independent manner, is operative to receive edits to existing data in the electronic document.

12. The system of claim 9, wherein the processor, in determining, using the business logic, whether the received data conforms with the at least one restriction on the current state of the data, is operative to determine, using the business logic, whether the current state of the data conforms with at least one of a pre-condition and a post-condition associated with the submission of data for at least one form.

13. The system of claim 9, wherein the processor, in determining, using the business logic, whether the received data conforms with the at least one restriction on the current state of the data, is operative to determine, using the business logic, where the current state of the data falls within a workflow logic sequence of tasks associated with the submission of data for at least one form.

14. The system of claim 9, wherein the processor, in determining, using the business logic, whether the received data conforms with the at least one restriction on the current state of the data, is operative to determine, using the business logic, whether the current state of the data conforms with at least one of a rule, constraint, equation, and inequality defined by the business logic.

15. The system of claim 14, wherein the processor, in generating, in a user interface, a visualization when the received data does not conform with the at least one restriction on the current state of the received data in the electronic document, is operative to display a prompt to inform a user of the electronic document that at least a portion of the received data in the electronic document does not conform with the at least one of a rule, constraint, equation, and inequality defined by the business logic.

16. The system of claim 14, wherein the processor, in generating, in a user interface, a visualization when the received data does not conform with the at least one restriction on the current state of the received data in the electronic document, is operative to highlight at least a portion of the received data in the electronic document which does not conform with the at least one of a rule, constraint, equation, and inequality defined by the business logic.

17. A computer-readable storage medium comprising computer executable instructions which, when executed on a computer, will cause the computer to perform a method of providing a user interface for reusing business logic related to an ordered business process to manage data in an electronic document, comprising:
receiving edits to the data in the electronic document in an order-independent manner, the data comprising at least one of new data and edits to existing data, the data comprising metadata defining business logic comprising at least one restriction on a current state of the data;
determining, using the business logic, whether the current state of the data conforms with at least one of a rule, constraint, equation, and inequality defined by the business logic; and
generating, in a user interface, a visualization when the data does not conform with the at least one of a rule, constraint, equation, and inequality defined by the business logic, the visualization comprising at least one of: displaying a prompt to inform a user of the electronic document that at least a portion of the data in the electronic document does not conform with at least one of a rule, constraint, equation, and inequality defined by the business logic and highlighting at least a portion of the data in the electronic document which does not conform with the at least one of a rule, constraint, equation, and inequality defined by the business logic.

18. The computer-readable storage medium of claim 17 further comprising utilizing a database to track the current state of the data.

19. The computer-readable storage medium of claim 17, wherein determining, whether the current state of the data conforms with at least one of a rule, constraint, equation, and inequality defined by the business logic comprises determining whether the current state of the data conforms with at least one of a pre-condition and a post-condition associated with the submission of data for at least one form.

20. The computer-readable storage medium of claim 17, wherein determining, whether the current state of the data conforms with at least one of a rule, constraint, equation, and inequality defined by the business logic comprises determining whether the current state of the data falls within a workflow logic sequence of tasks associated with the submission of data for at least one form.
